(19) United States
(12) Patent Application Publication
(10) Pub. No.: US 2002/0175309 A1
(43) Pub. Date: Nov. 28, 2002

(54) Pneumatically-actuated membrane valve for fluid branching ducts

(75) Inventor: Marco Vernia, Rubiera (IT)

Correspondence Address: MODIANO & ASSOCIATI, Via Meravigli, 16, 20123 MILANO, IT

(73) Assignee: ARAG-S.R.L. CON SOCIO UNICO

(21) Appl. No.: 10/146,879

(22) Filed: May 17, 2002

(30) Foreign Application Priority Data
May 25, 2001 (IT) MO2001A000105

(51) Int. Cl. F16K 1/00

(52) U.S. Cl. 251/331

(57) ABSTRACT

A pneumatically-actuated membrane valve for fluid branching ducts comprises an internally hollow cylinder associable with an end of the duct that is substantially coaxial thereto and inside which a plunger is slidingly accommodated, the head of the plunger being adapted to interact with a circular membrane for closing the end of the duct. The plunger is actuated pneumatically between a closed or open configuration, and an open or closed configuration of the end of the branching duct, at least one abutment for stopping the stroke of said plunger being formed inside the cylinder.

### BACKGROUND OF THE INVENTION

The present invention relates to a pneumatically-actuated membrane valve for fluid branching ducts.

Spraying machines are known in the agricultural field and are used to distribute fluid products for herbicidal, fungicidal, insecticidal treatments or the like.

Spraying machines are substantially constituted by a chassis that supports a fluid tank, which is associated with a pumping assembly that feeds one or more sprayer bars designed to distribute the fluid; spraying machines are fixed or towed by a tractor that travels along the crop to be treated.

The sprayer bars, which are horizontal for herbaceous crops and vertical or arc-like for arboreal crops, are constituted by a supporting frame that is associated with said chassis and tubes for conveying the fluid are fixed thereto; said tubes are fed by the pumping assembly with the interposition of flow-rate regulation and control valves.

Multiple assemblies for branching and delivering the fluid are mounted along the tubes, and each assembly is provided with a respective closure valve that is designed to open and close it and prevent the dripping of the fluid if it is closed.

In particular, each branching assembly is constituted by an outer duct and an inner duct, which are coaxial one another and between which there remains a gap.

At a first end, the outer duct is connected to the conveyance tube from which it receives the fluid, while the inner duct is connected to fluid dispensing means, constituted for example by one or more nebulization nozzles.

At the opposite end, the two ducts, the outer one and the inner one, are connected one another and associated with the closure valve.

The closure valve is substantially constituted by a closure element that is alternately adapted to take up an open configuration, in which the fluid passes from the outer duct to the inner one and reaches the nebulization nozzles, and a closed configuration, in which the two ducts are isolated one another, so that the fluid does not reach the nozzles.

Spring-loaded valves are known which essentially have an antidrip function and are constituted by a circular membrane that is kept pressed against the ends of the ducts by a preloaded compression spring.

The fluid introduced in the gap between the two ducts applies to the membrane a pressure that overcomes the resistance of the spring and thus moves the membrane away, connecting the outer duct to the inner duct.

Said valves are actuated directly by the fluid; as an alternative to them, pneumatically-actuated piston valves of the normally-open or normally-closed type are known which are constituted by a cylinder which accommodates, so that it can slide with a reciprocating rectilinear motion, a piston which is provided, at its head, with a flow control element for the inner duct of the branching assembly.

Under the action of a stream of compressed air, the piston is made to alternately slide between the open configuration, in which the flow control element is extracted from the inner duct, which is thus connected to the outer one, and the closed configuration, in which the flow control element is extended into the inner duct, closing it and preventing the passage of the fluid that arrives from the outer duct.

Disadvantageously, said piston valves suffer drawbacks, including the fact that deposits of fluid form on the flow control element and reduce the efficiency of said valves and therefore have to be eliminated periodically.

This forces the execution of frequent maintenance and cleaning interventions, which are very long and laborious because they require the disassembly and reassembly of the valves.

As an alternative, pneumatically-actuated membrane valves of the normally-open or normally-closed type are known which are constituted by a cylinder inside which a plunger is mounted so that it can slide with a reciprocating rectilinear motion; the head of said plunger pushes a disk-like membrane for closing the ends of the inner and outer ducts of the branching assembly.

A stream of compressed air moves the plunger between the open configuration, in which the membrane is moved away and the two ducts are connected, and the closed configuration, in which the membrane is kept pressed against the two ducts, preventing their connection.

Normally-open membrane valves of the above described type have a reaction spring which, in the absence of an air stream, keeps the plunger in the configuration for opening the branching assembly, and air is introduced in order to move it to the closed configuration.

Normally-closed membrane valves instead have a reaction spring which, in the absence of an air stream, keeps the plunger in the configuration for closing the branching assembly, and air is introduced in order to move it to the open configuration.

Normally-closed valves offer greater assurances of safety in the case of incorrect or failed operation of the pneumatic system.

However, said membrane valves also suffer some drawbacks, including the fact that in passing from the open configuration to the closed configuration the membrane strikes and collides repeatedly against the end of the inner duct, becoming worn and damaged until it quite soon breaks.

This entails undesirable losses of fluid and the need for frequent replacements of the membrane, with a consequent increase in maintenance times and costs.

It is also noted that this drawback is more frequent in the case of normally-closed valves.

### SUMMARY OF THE INVENTION

The aim of the present invention is to eliminate the drawbacks described above of conventional closure valves by providing a pneumatically-actuated membrane valve for fluid branching ducts, which allows to prevent the membrane from being subjected to collisions and sudden impacts and to limit the damage and breakages to which said membrane is subjected, thus ensuring fluid tightness and reducing the number of interventions for maintenance and replacement, with a consequent time and cost saving.

Within this aim, an object of the present invention is to achieve the above aim with a structure that is simple, relatively easy to provide in practice, safe in use, effective in operation, and relatively low in cost.

This aim and this and other objects that will become better apparent hereinafter are achieved by the present pneumatically-actuated membrane valve for fluid branching ducts, of the type that comprises an internally hollow cylinder that is associable with an end of said duct that is substantially coaxial thereto and inside which a plunger is accommodated so that it can slide with a reciprocating rectilinear motion, the head of said plunger being adapted to interact with a circular membrane for closing said end of the duct, said plunger being actuated pneumatically between a closed or open configuration, and an open or closed configuration of said end, characterized in that inside said cylinder at least one abutment for stopping the stroke of said plunger is provided.

### BRIEF DESCRIPTION OF THE DRAWINGS

Further characteristics and advantages of the present invention will become better apparent from the detailed description of a preferred but not exclusive embodiment of a pneumatically-actuated membrane valve for fluid branching ducts, illustrated only by way of non-limitative example in the accompanying drawings, wherein:

FIG. 1 is a schematic perspective view of a branching duct for a fluid, provided with a valve according to the invention and supplying a delivery assembly;

FIG. 2 is an exploded view of FIG. 1;

FIG. 3 is a schematic longitudinal sectional view of the valve of FIG. 1 in the configuration for closing the branching duct;

FIG. 4 is a schematic longitudinal sectional view of the valve of FIG. 1, in the configuration for opening the branching duct.

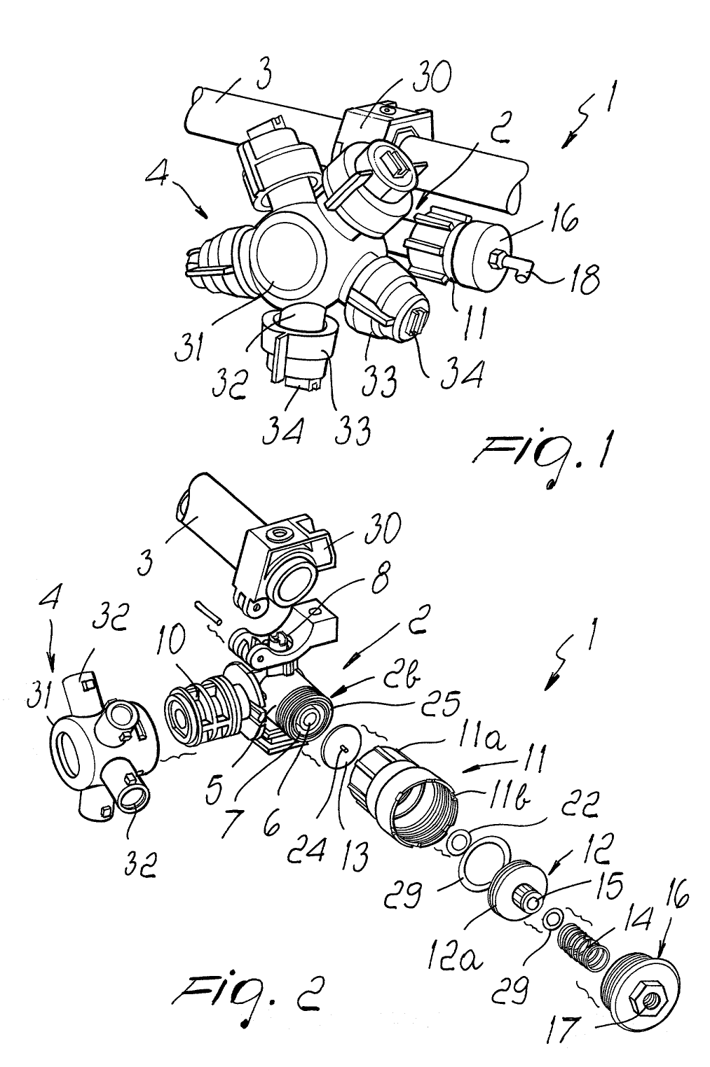

### DESCRIPTION OF THE PREFERRED EMBODIMENTS

With reference to the figures, the reference numeral 1 generally designates a pneumatically-actuated membrane valve for fluid branching ducts 2, particularly of the type for herbicidal, fungicidal, insecticidal treatments or the like, distributed on herbaceous or arboreal crops by agricultural spraying machines.

The spraying machines, not shown since they are of a conventional type, substantially comprise a chassis for supporting a tank of the fluid that supplies one or more horizontal or vertical sprayer bars constituted by a supporting frame to which conveyance tubes 3 are fitted, said tubes having valves for flow-rate adjustment and control.

Multiple branching ducts 2 are distributed along the tubes 3, feed the fluid into respective dispensing assemblies 4, and are provided with a respective opening and closure valve 1.

Each duct 2 is constituted by an outer duct 5 and by an inner duct 6, which are coaxial one another and between which a gap 7 remains.

The duct 2 has a first end 2a, which is closed and proximate to which the outer duct 5, and therefore the gap 7, is connected to the tube 3 by means of an inlet connector 8, while the inner duct 6 is connected, by means of a hole 9, to a feeder duct 10 of the assembly 4.

The second end 2b of the branching duct 2 is open and the valve 1 is associated therewith.

The valve 1 comprises an internally hollow cylinder 11, which is arranged coaxially to the duct 2 and has an end 11a that can be rigidly coupled to the second end 2b.

A plunger 12 is accommodated inside the cylinder 11 so that it can slide with a reciprocating rectilinear motion, and its head interacts with a circular membrane 13 for closing the second end 2b; the plunger 12 is actuated pneumatically between a closed configuration and an open configuration of the second end 2b.

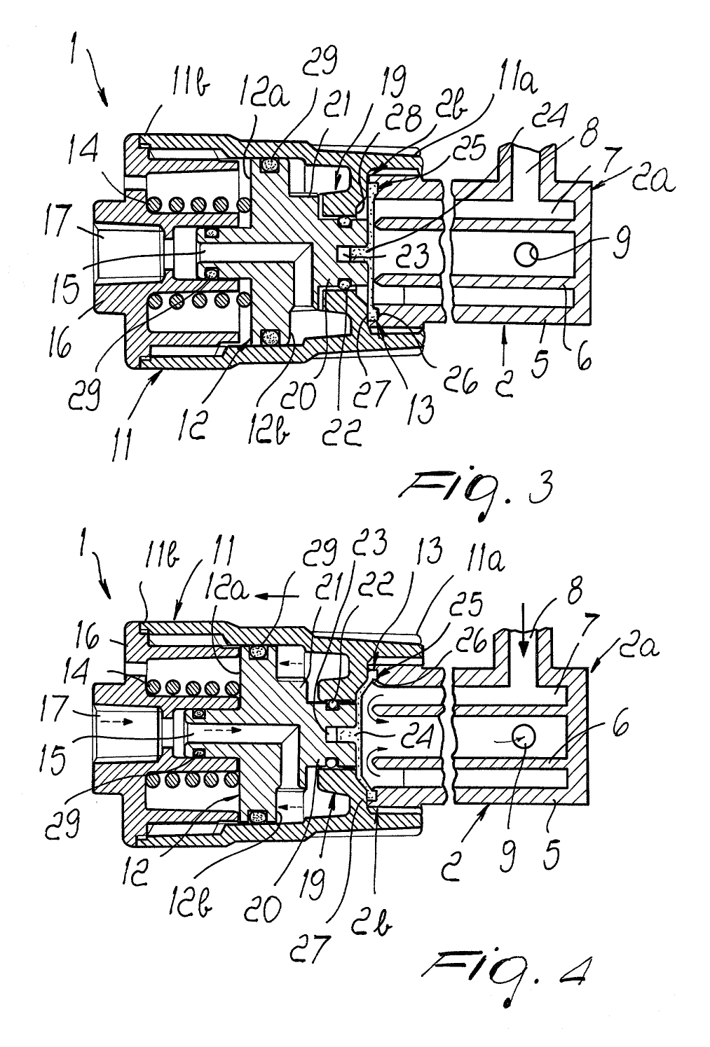

In the closed configuration (FIG. 3), the plunger 12 keeps the membrane 13 pressed against the second end 2b, closing it; in this manner, the gap 7 and the inner duct 6 are isolated one another, preventing the passage of the fluid from the inlet duct 8 to the feeder duct 10.

In the open configuration (FIG. 4), the plunger 12 moves the membrane 13 away from the second end 2b, opening it; in this manner, the gap 7 is connected to the inner duct 6, through which the fluid drawn from the inlet duct 8 flows into the feeder duct 10 to be dispensed by the assembly 4.

The valve 1 shown in the above figures is of the normally-closed type; a reaction spring 14 acts on the rear face 12a of the plunger 12 and, in the absence of an air stream, keeps it in the closed configuration; an air stream adapted to contrast the action of the spring 14 acts on the front face 12b of the plunger 12 so as to move the plunger 12 away from the second end 2b and move it into the open configuration.

A duct 15 is formed in the body of the plunger 12 in order to convey the air stream onto its front face 12b, while the end 11b of the cylinder 11 is closed by a lid 16, in which a hole 17 is provided for coupling a hose 18 for connection to a pneumatic system.

The valve 1 further comprises an abutment 19 for stopping the outward stroke of the plunger 12, which is formed inside the cylinder 11 upstream of the membrane 13.

The illustrated abutment 19 is of the annular type; as an alternative, it can be constituted by protrusions, ridges or the like formed inside the cylinder 11; the abutment 19 is formed proximate to the perimetric edge of a cylindrical cavity for the sliding of the head of the plunger 12.

The head of the plunger 12 is constituted by a stem 20, which slidingly enters the inner cavity of the abutment 19 and at the base of which a collar 21 is provided that abuts against the rear face of the abutment 19.

On the lateral surface of the stem 20 a peripheral annular seat is provided for accommodating a gasket 22 for forming a seal against the internal wall of the cavity in which it slides, while at the top of the stem 20 a hole 23 is provided for inserting a pin 24 for centering the membrane 13.

At the second end 2b of the branching duct 2 means for centering the membrane 13 are provided which are constituted by an annular slot 25 which is formed on the edge of the outer duct 5 and in which a complementarily shaped ridge 26, formed so as to protrude on the perimeter of the membrane 13, is inserted.

An annular raised portion or protrusion 27 is formed on the front face of the abutment 19 and locks the perimetric ring or portion of the membrane 13 against the second end 2b of the branching duct 2 both in the open configuration and in the closed configuration.

The front face of the abutment 19 is further shaped so as to have a chamfered profile 28 that is adapted to accommodate the membrane 13 in the open configuration.

Furthermore, the reference numeral 29 designates sealing gaskets which are accommodated in corresponding seats formed in the plunger 12, and the reference numeral 30 designates the coupling of the duct 2 to the tube 3.

The assembly 4 is constituted by a support 31 that branches out into a plurality of radial ducts 32, whose output end is rigidly coupled to a sleeve 33 for the coupling of a respective nebulization nozzle 34.

The support 31 is rotatably associated with the feeder duct 10, whose outlet is selectively connected to the lower radial duct 32, to which the nozzle 34 is rigidly coupled, said nozzle being of a model adapted for nebulizing the fluid treatment to be distributed.

It is noted that the presence of the abutment 19 and of the collar 20 allows to prevent the membrane 13 from colliding against the end 2b of the duct 2 during the outgoing stroke of the plunger 12 under the action of the spring 14; the thrust of the spring 14 is in fact discharged predominantly onto the abutment 19.

In practice it has been found that the described invention achieves the intended aim and objects, i.e., it provides a pneumatically-actuated membrane valve for fluid branching ducts that allows to keep the membrane intact by preventing it from being subjected to damage and breakage due to impact.

The invention thus conceived is susceptible of numerous modifications and variations, all of which are within the scope of the appended claims.

All the details may further be replaced with other technically equivalent ones.

In practice, the materials used, as well as the shapes and the dimensions, may be any according to requirements without thereby abandoning the protective scope of the appended claims.

The disclosures in Italian Patent Application No. MO2001A000105 from which this application claims priority are incorporated herein by reference.

What is claimed is:

1. A pneumatically-actuated membrane valve for fluid branching ducts, of the type that comprises an internally hollow cylinder connectable with an end of said duct that is substantially coaxial thereto, comprising: a plunger accommodated in said hollow cylinder for performing a sliding reciprocating rectilinear motion; a circular membrane arranged in said hollow cylinder so that a head region of said plunger interacts therewith for closing said end of the duct, said plunger being pneumatically actuatable between a closed and an open configuration, and an open and closed configuration of said end; and at least one abutment provided inside said hollow cylinder for stopping strokes of said plunger.

2. The valve of claim 1, wherein said abutment is formed in said hollow cylinder upstream of said membrane and is adapted to stop an outward stroke of said plunger.

3. The valve of claim 1, wherein said abutment is substantially annular and delimits perimetrically a cylindrical cavity.

4. The valve of claim 3, wherein said head region of the plunger is constituted by a stem, said stem being inserted slidingly in said cylindrical cavity that is delimited perimetrically by said abutment.

5. The valve of claim 4, comprising a collar shaped for bearing against said abutment, which is formed in said plunger.

6. The valve of claim 4, further comprising a gasket, said stem comprising a peripheral annular seat for accommodating said gasket so as to form a seal against an inner wall of said cylindrical cavity.

7. The valve of claim 6, further comprising centering means for centering said membrane, which are formed at said end of the branching duct.

8. The valve of claim 7, wherein said centering means are constituted by an annular slot formed proximate to an edge of said end of said branching duct, and said membrane is provided with a complementary perimetric ridge that is shaped so as to enter said slot.

9. The valve of claim 4, wherein said abutment has a face that is directed toward said membrane, which is shaped with a chamfered profile that is adapted to accommodate the membrane in said open configuration.

10. The valve of claim 9, wherein said abutment is provided, on the face that is directed toward said membrane, with a protrusion for locking a perimetric portion of the membrane against said end of the branching duct.
